(19) United States
(12) Patent Application Publication
(10) Pub. No.: US 2004/0244269 A1
(43) Pub. Date: Dec. 9, 2004

(54) Fishing lure and hook method & apparatus

(76) Inventor: William F. Whipple, Kissimmee, FL (US)

Correspondence Address: William M. Hobby, III, 157 E. New England Avenue, #375, Winter Park, FL, 32789, US

(21) Appl. No.: 10/454,239

(22) Filed: Jun. 5, 2003

(51) Int. Cl. A01K 85/00

(52) U.S. Cl. 43/42.23

(57) ABSTRACT

A fishing lure and hook combination includes a fishing hook having a shank with a pointed end, said shrank having an eye on the other end thereof. The fishing lure has a front portion having an elongated bore therethrough for receiving a fishing line therethrough and a rear portion having a slit in the side thereof intersecting the front portion bore and sized for said fish hook eye to slide sideways therein. The fishing weight has an enlarged hollow area at the intersection of the front portion elongated bore and the rear portion slit sized for the fish hook eye to rotate therein so that sliding the hook of the eye sideways into the rear portion of the slit and rotating the eye, locks the fish hook to the lure.

### BACKGROUND OF THE INVENTION

This invention relates to an improved fishing lure and especially to a fishing lure having a weight and commonly used for artificial worm, jig and spinner bait fishing. The invention also relates to a new fishing lure in combination with a fishhook and a method for releasably securing the lure or weight to the eye portion of a fishhook.

Artificial or plastic worms, jigs and spinner baits are some of the most popular and versatile fishing lures in use today, both among the casual or amateur fishermen as well as among professional fishermen. The most common technique for the use of one such lure is to rig the worm in a hook, with the point of the hook buried in the plastic. When a fish takes the lure and the hook is “set”, the force of the hook pulls the hook out of the soft plastic and into the fish. Another popular rigging technique involves the use of an exposed hook point but with a wire weedguard covering the point of the hook to keep the lure from becoming snagged on grass, trees, and the like.

The weight in such lures is usually employed to keep the lure on the bottom of the lake, river or the like and to help in casting the lightweight lure. The weight may have the hook formed directly therein with the eye protruding from one end and the back from the other end. Most often, the weight is a conical or bullet shaped weight having an axial bore therethrough. The fishing line passes through the axial bore and the weight is free to slide along the line.

One reason that the weight is allowed to slide along the line is to make it more difficult for a fighting fish to use the weight to its advantage and dislodge the hook during the fight. When the weight slides up the line, as during the fighting of the fish, only a small amount of weight is preset in the vicinity of the hook, generally limited to the weight of the bare hook and the plastic worm, and very little leverage is present, so that it is far more difficult for the hook to be dislodged.

However, with a freely sliding weight on the line, it often happens during fishing that the weight will slide up the line before a fish is hooked. As a result, fishermen have developed a technique for “pegging” the sinker. With this technique, a small piece of wood, for example, the end of a toothpick, is forced into the axial hole at the small end of the sinker. The wood clamps the line against the side of the hole to prevent the sinker from sliding on the line. When the hook is set into a fish, the force of the hookset is adequate to release the piece of wood so that the weight is again free to slide. Each time that the hook is set, whether a fish is hooked or not, the wood toothpick, must be replaced.

The disadvantage of pegging the weight is that the fish line tends to be crimped and thus weakened, at a point very close to the hook.

An object of the present invention is to provide an improved fishing weight for use with plastic or artificial worms, jig and spinner baits which releasably grips the eye of the fishhook for releasably holding the weight in place against the plastic worm.

Prior art patents which removably or releasably connect the eye of a fishing hook to a lure or to a weight can be seen in the following U.S. patents. The Crumrine U.S. Pat. No. 5,535,540 teaches a jigging system in which the jigging weight and the lure may be changed out without the necessity of removing the hook from the line. The Hedman U.S. Pat. No. 4,219,956 shows a weedless fish lure in which the barb of the hook extends into the midsection of a pliable lure body. The Stazo U.S. Pat. No. 4,791,749 shows a typical fishing lure having a weighted head having a hook formed therein for holding the eye of a hook which extends through the polymer body of the lure. The Crumrine U.S. Pat. No. 5,832,655 provides a fishing lure having a locking hook and sinker in which the eyelet of the hook connects the hook to a J-shaped connector on the end of a coil spring.

In the Blackwell U.S. Pat. No. 5,335,441, an artificial fishing lure has a head portion having a generally tubular body with a bayonet type slot for inserting the eye of a specially shaped fishing hook. The Link et al. U.S. Pat. No. 4,942,689 is a fishing weight for use with artificial worm fishing in which the weight is combined with a fish hook to releasably secure the weight to the eye portion of the fish hook. The leaded portion of the hook has a rubber coating filling a recess of the leaded weight and has a cavity formed in the rubber coating which allows the eye of the fishhook to be forced into the spherical cavity to hold the hook to the lure until such time as the hook is pulled loose by a fish striking the lure.

### SUMMARY OF THE INVENTION

A fishing weight and hook combination has a fishing hook having a shank having a barbed point at one end and an eye for attaching a fishing line at the other end thereof. The fishing weight has a front portion having an elongated bore therethrough for receiving a fishing line therethrough and a rear portion having a slit in the side thereof intersecting the front portion bore and sized for the fish hook eye to slide sideways therein. The fishing weight has an enlarged hollow area at the intersection of the front portion elongated bore and the rear portion slit sized for the fishing hook eye to rotate therein so that sliding the eye of the hook sideways into the rear portion of the slit and rotating the eye, locks the fishing hook to the weight. A soft plastic worm may then be slid over the hook and against the weight to hold the hook eye in a rotated and locked position in the weight. The fishing line passes through the front portion bore and attaches to the hook eye. The fishing hook may rotate on the fishing weight with the shank moving in the rear portion slit. The weight may be made of lead, brass or other metal and have a plurality of bores therein. The fishing lure may also be a spoon or other type lure.

A method of removably attaching a fishing hook to a fishing weight includes the step of selecting a fishing weight having a front portion having an elongated bore therethrough for receiving a fishing line therethrough and a rear portion having a slit in the side thereof intersecting the front portion bore and sized for the fishing hook eye to slide sideways therein. The fishing weight has an enlarged hollow area at the intersection of the front portion of the elongated bore and the rear portion slit sized to rotate the fishing hook eye therein. The process includes selecting a fishing hook having a shank with a barbed point at one end and an eye for attaching a fishing line at the other end thereof and sliding the end of the fishing line through the lure or weight front portion bore and out the slit in the weight rear portion and attaching the line to the eye of the hook. The hook is then slid into the rear portion slit with the eye turned sideways to the slit and the hook rotated to turn the eye within the enlarged hollow area to removably hold the hook to the fishing weight or lure. The process includes the step of attaching a soft pliable fishing lure body to the hook abutting the worm weight to hold the hook in place relative to the weight.

### BRIEF DESCRIPTION OF THE DRAWINGS

Other objects, features, and advantages of the present invention will be apparent from the written description and the drawings in which:

FIG. 1 is a perspective view of a fishing lure in accordance with the present invention;

FIG. 2 is a sectional view taken through the weighted head of FIG. 1;

FIG. 3 is a perspective view of the fishing lure of FIG. 1 with a sectional view through the head;

FIG. 4 is a partial perspective of FIG. 3 having the fishing line attached to the hook eye;

FIG. 5 is a partial perspective of FIGS. 3 and 4 having the hook eye inserted into the weighted head;

FIG. 6 is a side elevation of the lure of FIGS. 3, 4 and 5 having the hook attached to the weighted head;

FIG. 7 is a partial sectional view of the fishing lure of FIG. 3;

FIG. 8 is a partial sectional view of the fishing lure of FIGS. 1-7 having a weedless hook;

FIG. 9 is a partial sectional view of a fishing lure of FIGS. 1-8 having a single bore and spinner bait design;

FIG. 10 is a perspective view of a fishing lure of FIGS. 1-8 having a head with a single bore;

FIG. 11 is a partial sectional view of the fishing lure of FIG. 10;

FIG. 12 is a partial sectional view of the fishing lure of FIG. 10 having a weedless hook;

FIG. 13 is a partial sectional view of the fishing lure of FIG. 11 having the fishing hook attached with the barbed point through the tail of the body;

FIG. 14 is a perspective view of an alternate embodiment of the present invention having a solid lure;

FIG. 15 is a partial sectional view of the lure of FIG. 14 showing the hook eye being inserted into the body;

FIG. 16 is the partial sectional view of FIG. 15 having the hook eye twisted for locking the hook to the body;

FIG. 17 is a partial sectional view of the lure of FIGS. 14-16 illustrating the movement of the hook shank and barbed point within the solid body;

FIG. 18 is a perspective view of a fishing spoon lure having the present invention incorporated therein;

FIG. 19 is a sectional view of the spoon of FIG. 18;

FIG. 20 is a sectional view of the spoon of FIGS. 18 and 19 having the hook eye inserted into the lure;

FIG. 21 is a sectional view of the lure of FIG. 20 having the hook rotated to lock the eye to the spoon; and

FIG. 22 is a sectional view of the lure of FIGS. 18-21 having a weedless hook attached thereto.

### DETAILED DESCRIPTION OF THE PREFERRED EMBODIMENT

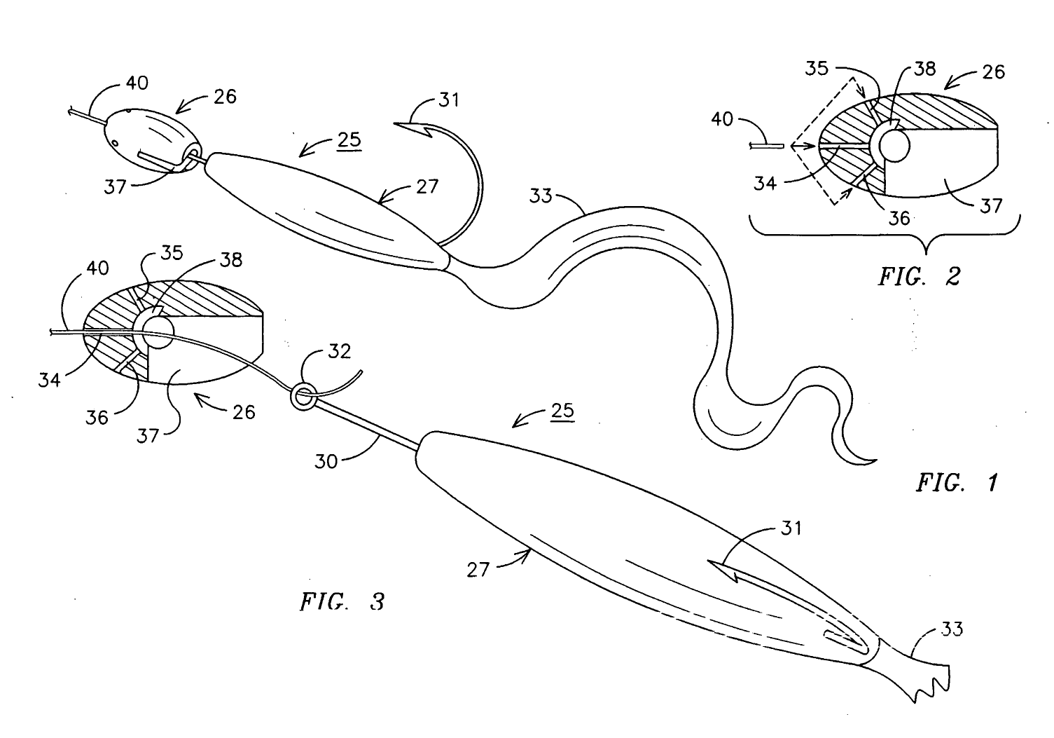

Referring to the drawings and especially to FIGS. 1-6, a fishing lure 25 is illustrated in FIG. 6 of the type having a weighted head 26 and a soft pliable polymer body 27 which may be a plastic worm type lure. The weighted head 26 and plastic lure body have a hook 28 attached thereto having a shank 30 with a barbed end 31 and a hook eyelet 32 on the other end thereof. The soft pliable body 27 may have a flexible tail 33 attached to the end thereof. The lead head 26 has an axial bore 34 extending through the front thereof but may also have additional bores 35 and 36, each of which extends through the front portion of the head 26. The rear portion of the head 26 has a slit 37 extending in from the side thereof and intersecting an enlarged hollow or recessed area 38. In addition, the bores 34, 35 and 36 intersect the recessed area 38. A fishing line 40 is illustrated attached to the hook eye 32. The fishing line 40 is threaded through the bore 34, 35 or 36, through the recessed area 38 and out the slit 37 where it is attached to the hook eye 32, as shown in FIG. 3. The soft pliable body 27 can be attached to the hook before the line is attached to the eye or alternatively can be attached to the hook after the fishing line 40 has been attached to the eye and the hook attached to the weighted head 26. As seen in FIGS. 1-6, the fishing hook eye 32 is turned sideways and slipped into the slit 37 and into the recessed area 38 where it is rotated 90 degrees to lock the eye within the recessed area 38 to lock the hook in place. It should be noted that the hook can still rotate with the shank 30 sliding in the slit 37 but will not come loose from the head 26 until the eye is rotated back into alignment with the slit 37.

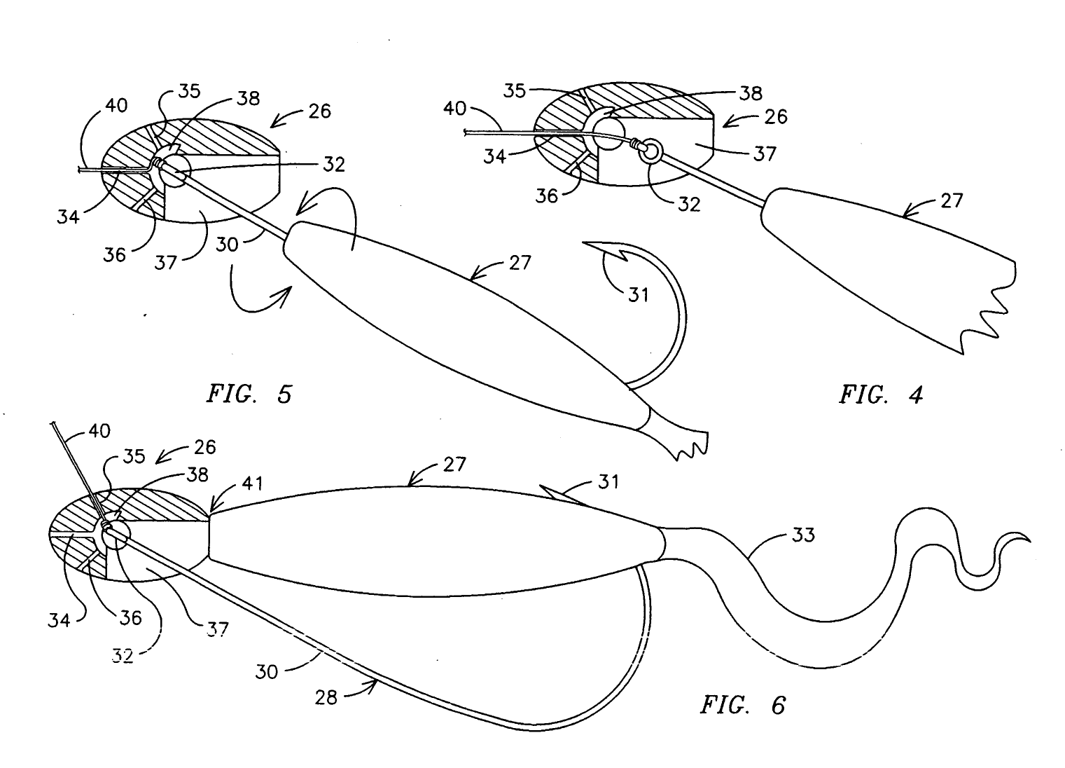

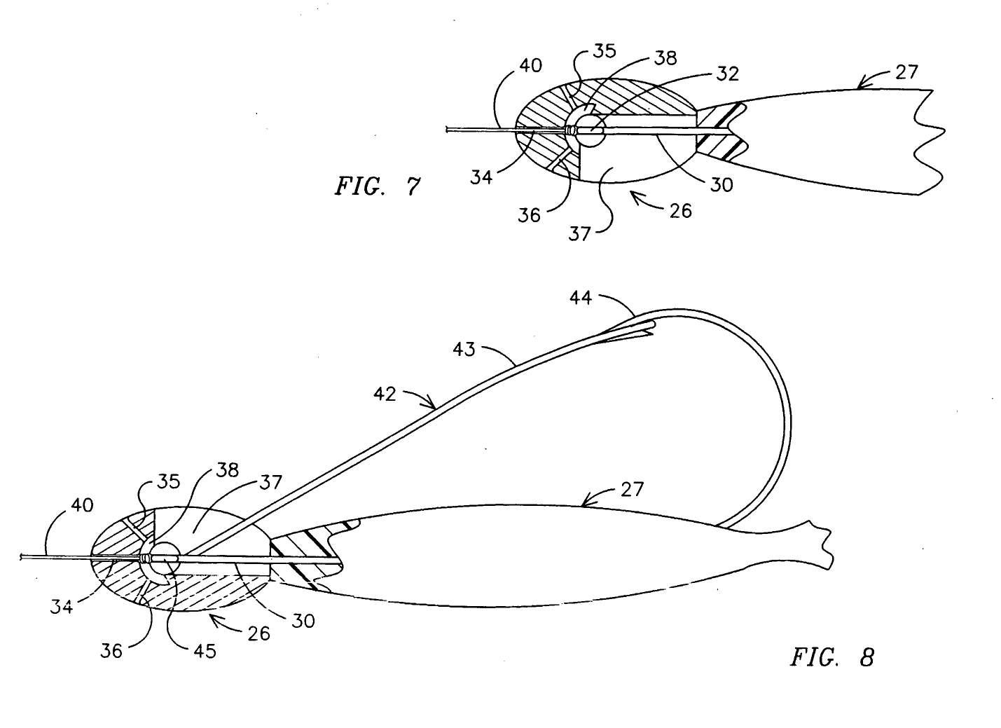

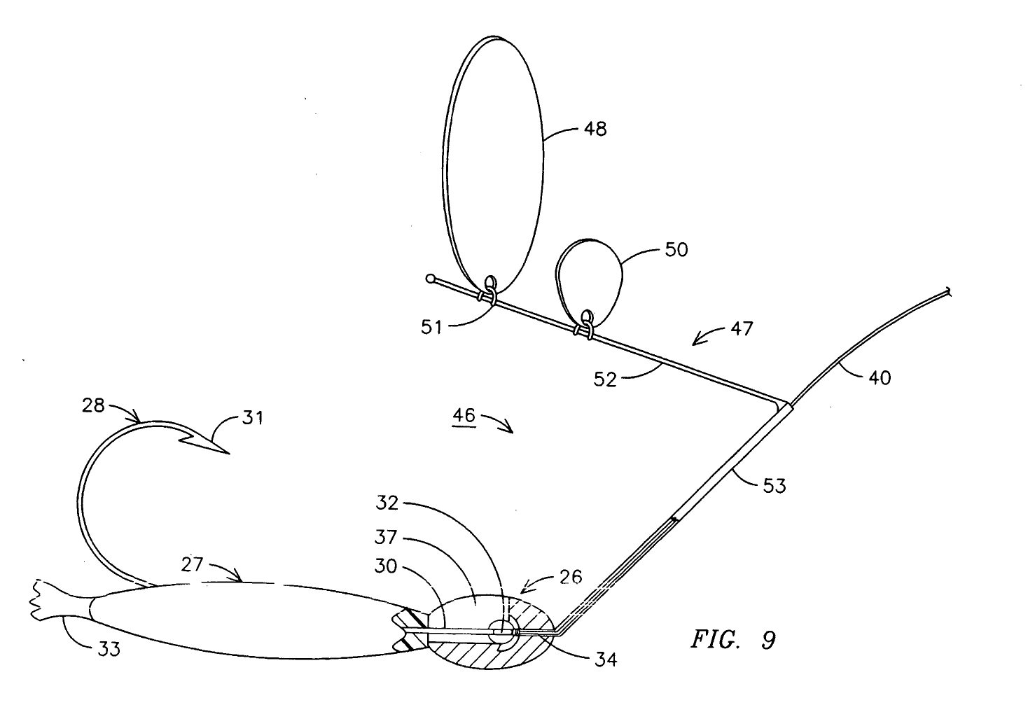

Once the hook is attached, the soft polymer worm body 27 can be slid into abutment with the weighted head 26, such as at the abutment 41 in FIG. 6, and the hook 28 can have its barbed end driven into the polymer body 27 which prevents the hook from rotating relative to the head 26 and thus holds the hook locked to the head. FIG. 8 shows a slightly modified embodiment in which a weedless hook 42 is utilized with the weighted head 26 and operates in the same manner except for the weedless extension 43 connected to a portion of the hook and extending to the barbed end 44 of the hook 42. The eyelet 45 of the hook is attached to the head 26 in the same way as in FIGS. 1-7 while the line 40, in this embodiment, is illustrated extending through the central axial bore 34.

The fishing lure 46 of FIG. 9 is an embodiment having the head 26 and the soft pliable body 27 having the hook 28 extending therethrough. The additional fish attracting member 47 has a large silver spinner plate 48 and a smaller silver spinner plate 50 movably attached to rings 51 attached to a spring wire member 52 which in turn is attached to a sleeve 53 over the fishing line 40. The sleeve 53 extends into the axial bore 34. The sleeve 53, in addition to shaking the silver plates 48 and 50, holds the lure 46 relative to the line 40 by the stiffer sleeve 53 which is supported at an angle to the head 26.

Turning to FIG. 10, a fishing lure 25, in accordance with the lure in FIGS. 1-6, has the weighted head 26 and the soft pliable body 27 having the hook 28 passing therethrough with the hook shank 30 extending into the slit 37 with the fishing line 40 extending out the front bore. The lure body 27 has a tail 33 extending therefrom.

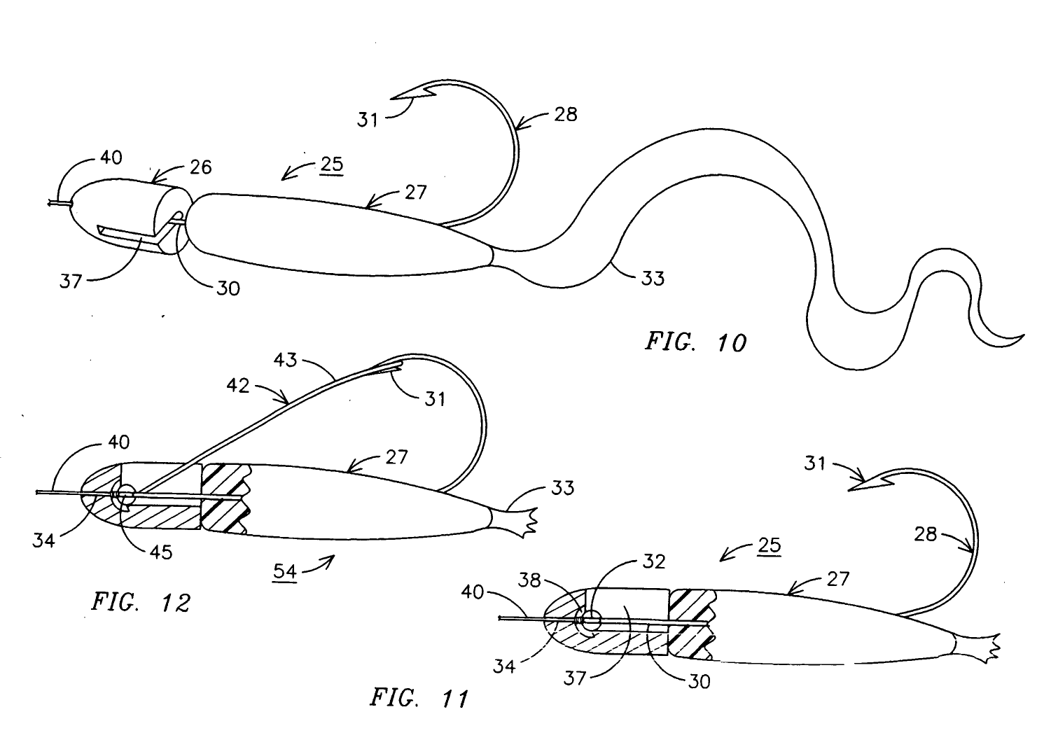

FIG. 12 illustrates the fishing lure 54 having the weedless hook 42 therein with the weedless member 43 extending to the barb 31 with the body 26 attached to the head 26 and extending into the slit 37 with the eye within the recessed area 38 and the fishing line 40 extending through the axial bore 34.

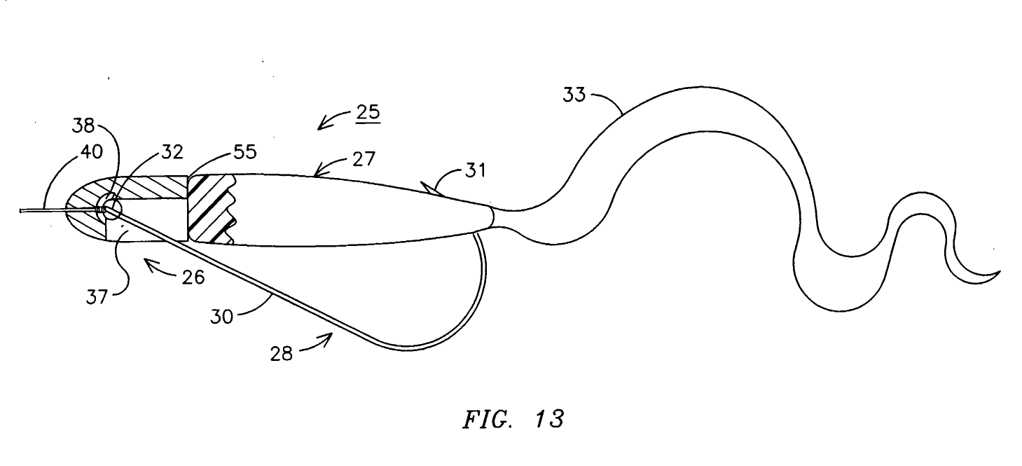

In FIG. 11, the fishing lure 25 of FIG. 10 has a cutaway section showing the slit 37 with the eye of the fishing hook 28 within the recessed or hollow area 38 having the fishing line 40 attached thereto and extending through the bore 34. The soft body 27 is shown abutting the weighted head 26. The fishing lure 25, is shown in FIG. 13, has the head 26 and the slit 37 having the hook 28 extending therefrom and attached to the line 40 with the eye of the hook within the recessed to hollow area 38. The soft pliable body 27 has the tail 33 extending therefrom and the barb 31 of the hook 28 extending through the soft pliable body 27. The soft pliable body 27 abuts the rear end 55 of the head 26 so that the hook 28 is held in position with eye 32 rotated in the recessed area 38 to prevent the hook from coming loose from the weighted head 26.

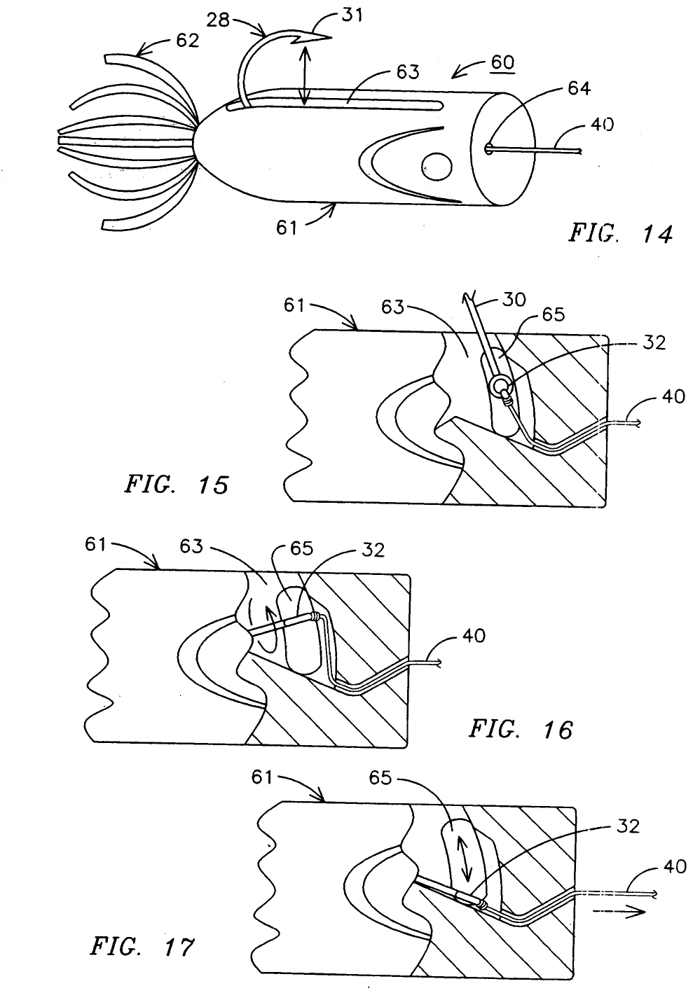

Turning to FIGS. 14-17, a fishing lure 60 has a fishing lure body 61 with a tail 62 extending therefrom. The body 60 has a narrow slit 63 extending thereinto and a bore 64 extending axially into the front of the lure. The fishing line 40 extends through the bore 64 which has an indirect or bent passageway, as seen in FIGS. 15, 16 and 17. Fishing hook 28 has the eye 32 on one end attached to the fishing line 40 and the barbed point 31 on the other end thereof. In this embodiment, the fishing line is attached to the fishing hook 28 eye 32 and then the eye is inserted sidewise into the slit 63, as shown in FIG. 15, and rotated, as shown in FIG. 16, to lock the eye and fishhook in place, as shown in FIG. 17, within a recessed area 65, which is an elongated area which allows the hook to swing in and out of the slit 63 while held to the lure 61. The hook sliding within the slit 63 prevents the hook from rotating and coming away from the lure.

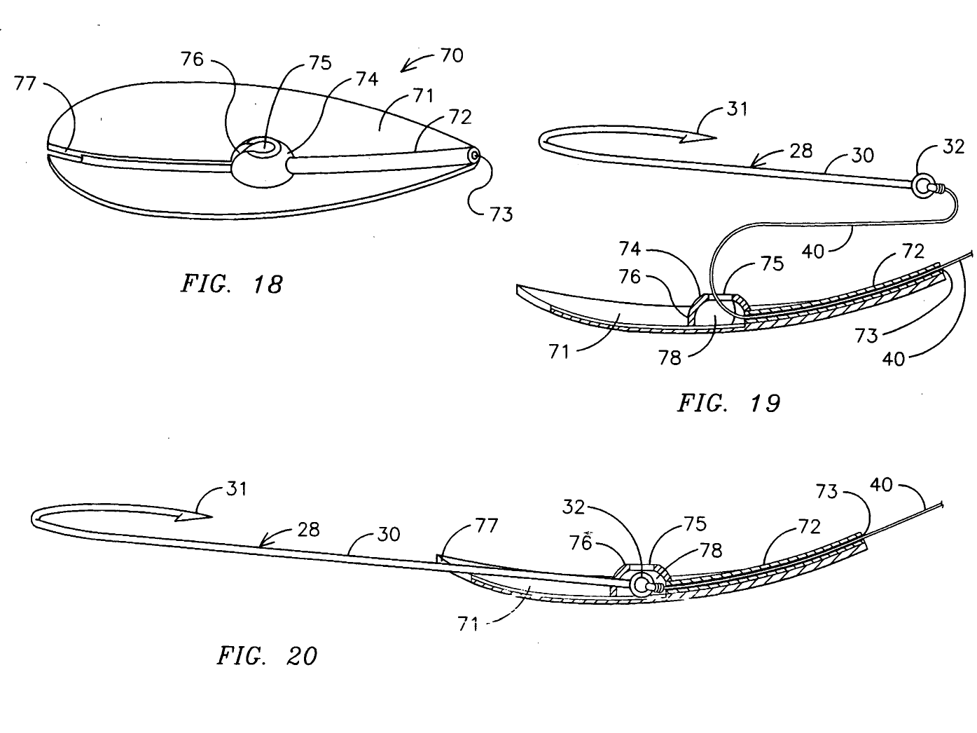

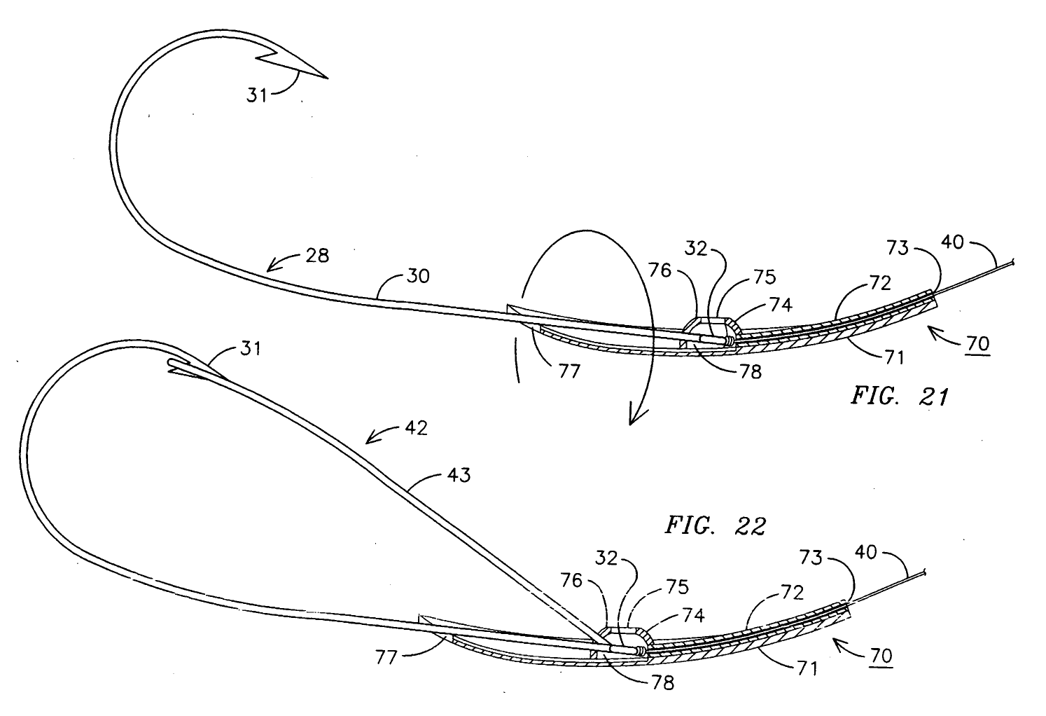

In FIGS. 18-22, another embodiment of the present invention is illustrated in which a spoon lure 70 has the basic spoon body 71 which has a sleeve 72 fixedly attached thereto forming a bore 73 feeding into a raised area 74 on the top of the spoon which has an opening 75 therein and a slit 76 formed therein. The spoon 70 body 71 also has a rear slot 77 formed therein. The fishing line 40 is threaded through the sleeve portion 72 and out the opening 75 where it is attached to a hook 28 or to a weedless hook 42. The hook 28 can then be turned sideways for the eye 32 to slide in the opening 75 and the shank 30 to slide within the slit 76 and also to slide within the slot 77, as shown within FIGS. 18-21. The hook 28 can then be rotated, as seen in FIG. 21, to upright the hook point 31 and to lock the eye 32 within the hollow area 78 of the raised body portion 74. In the case of the weedless hook 42, the weedless extension 43 extends to cover the pointed, barbed end 31.

It should be clear at this time that a fishing lure with a flexible polymer body and weighted head can easily have the hook removably attached to the weighted head but that the attachment can also be made to a spoon lure which has been modified to removably attach the hook thereto and that the hook, whether a weedless or a conventional fishing hook, can be attached to a solid lure. The process includes selecting a weighted head or soft polymer lure body having a bore for a fishing line intersecting a slit in the head with the recessed area or, alternatively, selecting a spoon lure as the weight having the bore therein intersecting a recessed area having a slit therein or selecting a solid lure having a bore therein intersecting a slit therein and having a hollow area at the intersection of the front bore in the rear slit. Then selecting a fishhook having an eye on one end and a barbed point on the other end and sliding the eye in sideways into the slit of the lure or the head of the lure, rotating the eye within the enlarged hollow area to lock the hook in place. The process can also include attaching a soft pliable polymer body of the weighted head lure to the hook to support the hook in position as well as to partially conceal the hook. However, the present invention should not be limited to the forms shown which are to be considered illustrative rather than restrictive.

I claim:

1. A fishing lure and hook combination comprising:
a fish hook having a shank having a barbed point at one end and an eye for attaching a fishing line at the other end thereof;
a fishing lure having a front portion having an elongated bore therethrough for receiving a fishing line therethrough and a rear portion having a slit in the side thereof intersecting said front portion bore and sized for said fish hook eye to fit sideways therein, said fishing lure having an enlarged hollow area at the intersection of said front portion elongated bore and said rear portion slit sized for said fish hook eye to rotate therein; whereby sliding said hook eye sideways into said fishing lure rear portion slit and rotating said eye locks said fishing hook to said lure.

2. The fishing lure and hook combination in accordance with claim 1 in which said hook eye has a fishing line passing through said front portion bore and attached thereto.

3. The fishing lure and hook combination in accordance with claim 2 in which fishing lure is a weight and said hook has a soft pliable lure body portion attached thereto abutting said weight to hold said hook eye against rotation.

4. The fishing lure and hook combination in accordance with claim 1 in which said fish hook is attached to said fishing lure for the pointed end to rotate into and out of said fishing lure.

5. The fishing lure and hook combination in accordance with claim 1 in which said fishing lure is a spoon lure.

6. The fishing lure and hook combination in accordance with claim 3 in which said fishing lure is a weight made of metal.

7. The fishing lure and hook combination in accordance with claim 3 in which said fishing weight front portion has a plurality of bores therein intersecting with said rear portion slit.

8. A method of removably attaching a fishing hook to a fishing lure comprising the steps of:
selecting a fishing lure having a front portion having an elongated bore therethrough for receiving a fishing line therethrough and a rear portion having a slit in the side thereof intersecting said front portion bore and sized to fit said fish hook eye sideways therein, said fishing lure having an enlarged hollow area at the intersection of said front portion elongated bore and said rear portion slit sized to rotate said fish hook eye therein;
selecting a fish hook having a shank and a pointed end and an eye for attaching a fishing line on the other end thereof;
sliding the end of a fishing line through said lure front portion bore and out the slit in said lure rear portion;
attaching a fishing line to the eye of said hook;
sliding said hook having a fishing line attached thereto into said rear portion slit with the eye turned sideways to the slit and rotating said hook to turn said eye within said enlarged hollow area to movably hold said hook to said fishing lure;
whereby sliding said fish hook eye sideways into the rear portion slit of said lure and rotating said eye within the enlarged hollow area of said lures removably locks said fish hook to said lure.

9. The method of removably attaching a fishing hook to a fishing lure in accordance with claim 8 including the step of attaching a soft pliable fishing lure body to said hook abutting said lure.

10. The method of removably attaching a fish hook to a fishing lure in accordance with claim 8 in which the step of selecting a fishing lure includes selecting a spoon type lure.
